(19) United States
(12) Patent Application Publication
(10) Pub. No.: US 2026/0314821 A1
(43) Pub. Date: Oct. 15, 2026

(54) MAGNETIC DRAWER ORGANIZER

(71) Applicant: Century Components, LLC, Sugarcreek, OH (US)

(72) Inventors: Brendan Lee Mullet, Fresno, OH (US); William E. Sewell, Holland, MI (US)

(21) Appl. No.: 19/177,832

(22) Filed: Apr. 14, 2025

(51) Int. Cl. A47B 88/981; F16B 12/42

(52) U.S. Cl. CPC A47B 88/981; F16B 12/42; F16B 2200/83

(57) ABSTRACT

A magnetic organizer for a drawer or cabinet, said organizer comprising an insert and at least on peg. The insert is disposed within the drawer or cabinet and has a base formed with a recess for receiving a sheet formed from a ferromagnetic material or paramagnetic material. The at least one peg has another recess for receiving a magnet. The at least one peg is removably attached to the insert by the magnet.

### BACKGROUND

### TECHNICAL FIELD

The present invention relates generally to the art of cabinetry. In particular, the present invention relates to cabinetry that utilizes organizers. More particularly, the present invention relates to a cabinet or drawer organizer that utilizes one or more pegs removably attached by a magnet to a trimmable drawer insert having a ferromagnetic or paramagnetic layer to provide a robust and fully customizable storage solution that facilitates faster and more accurate installation and fits within a unitized drawer or cabinet while providing support for, and division of, kitchenware without requiring holes, openings, or recesses formed in the organizer that accumulate dust, debris, and/or particulate, thereby preventing unsanitary conditions.

### BACKGROUND ART

Closed storage that provides concealed, efficient storage for, and easy access to, kitchenware in modern kitchen design is well-known. Common types of closed storage typically include drawers and cabinets. For the purposes of clarity and convenience, reference is made to kitchenware with the understanding that such reference includes food storage containers, bakeware, cookware, cooking utensils, dishes, knives, cutting boards, serveware, and the like.

Cabinets are generally formed from a frame with a pair of opposing side panels arranged in parallel with one another. The side panels are each attached at a respective edge to and separated by a back panel disposed perpendicularly between the side panels. The frame also includes a floor extending perpendicularly between and attached to the respective lower edges of the side and back panels. A face frame is typically attached to the front of the side panels and floor, creating a surround that defines one or more front openings of the cabinet. A top panel or countertop is typically attached to the respective top edges of the side and back panels and face frame of the cabinet and may span adjacent cabinets, as is known. One or more cabinets may also be constructed in a unitized fashion, wherein the cabinet is constructed in place and utilizes a wall of the room in which the cabinets are placed as the back panel.

Cabinets may be built to accommodate one or more drawers, as is known. More specifically, each drawer may be slidably and removably mounted within a cabinet by drawer slides, as is known. Drawers are generally formed as a box having a front and a back panel and a pair of side panels. The front and back panels are typically arranged in parallel with each other and are perpendicular and attached to the side panels. A bottom panel extends perpendicularly between and is attached to the front, back, and side panels. A drawer front, or face, is attached to the outward-facing surface of the front panel. Drawers can typically have varied dimensions to allow for the storage of items of varied size and number, as is known. More recently, it has become popular in the art to utilize drawers for the storage of kitchenware. In order to increase the efficiency and organization of the drawers when utilized to store various items of disparate size and shape, such as kitchenware, prior art drawer organizers have been utilized.

Prior art drawer organizers have taken a number of forms, including wire frames inserted into the bottom panel of the drawer. Most recently, however, prior art drawer organizers have been popularized that utilize a number of holes, openings, or recesses at least partially formed into the bottom panel of the drawer, or a board or insert made of wood or MDF sized to fit into the drawer, and arranged in a grid pattern. Such prior art drawer organizers also utilize cylindrical wooden dowels or pegs having pins or rods that are complementarily-sized to fit into the holes, openings, or recesses of the drawer bottom panel or insert. Alternatively, the pegs may have radial dimensions that allow them to be inserted into the recesses formed into the bottom panel or insert. As such, a number of the pegs are able to be selectively inserted into respective holes, openings, or recesses to act as dividers, anchor or retention points, or support for kitchenware, allowing for the stacking and arrangement of stored items of various sizes and shapes while maintaining separation between the stored items, thereby increasing the efficiency and organization of the drawer contents. In addition, because the prior art drawer organizers are made of wood and/or MDF, they can be trimmed or cut to appropriate size for use in any drawer.

Prior art drawer organizers, while generally suitable for their intended purpose, have disadvantages, drawbacks, and limitations. For instance, as discussed above, prior art drawer organizers typically utilize openings or recesses formed at least partially into the bottom panel of the drawer or an insert. However, not every opening or recess may be utilized to retain a dowel or peg. As a result, a number of the openings or recesses may be uncovered and exposed, allowing for the accumulation of dust, debris, and the like, thereby potentially leading to unsightly and unsanitary conditions in which kitchenware may be stored. Moreover, because the openings or recesses are arranged in a grid, prior art drawer organizers are more limited in customizability, such that storage of irregularly shaped items may potentially be more complex or result in unutilized space within the drawer, thereby decreasing the efficiency of the organizer.

Thus, there is a need in the art for an organizer for drawers or cabinets having a ferromagnetic material disposed within a trimmable insert that facilitates faster and more accurate installation of the organizer within a unitized drawer or cabinet and utilizes a number removably attachable pegs to provide completely customizable placement for the support and division of stored items within the drawer or cabinet while minimizing crevices, holes, and/or openings formed in the organizer that collect dirt and debris, thereby preventing the accumulation of unsanitary conditions.

### SUMMARY OF THE INVENTION

Objectives of the present invention include providing an organizer for drawers or cabinets having a trimmable base that facilitates faster and more accurate installation within a unitized drawer or cabinet.

Yet another object of the present invention is to provide an organizer for drawers or cabinets that utilizes a number of repositionable pegs to provide completely customizable placement for the support and division of stored items within a drawer or cabinet.

A further objective of the present invention is to provide an organizer for drawers or cabinets that eliminates the need for holes, openings, and/or recesses formed into the organizer that accumulate dirt, debris, and/or particulate in order to prevent unsanitary conditions and create a more aesthetically pleasing appearance.

These objectives and advantages are obtained by the magnetic organizer, according to the present invention, for a drawer or cabinet, the organizer comprising an insert disposed within the drawer or cabinet and having a base formed with a recess for receiving a sheet, the sheet being formed from a ferromagnetic material or paramagnetic material, and at least one peg, the at least one peg having another recess for receiving a magnet, wherein the at least one peg is removably attached to the insert by the magnet.

### BRIEF DESCRIPTION OF THE SEVERAL VIEWS OF THE DRAWINGS

The preferred embodiment of the present invention, illustrative of the best mode in which Applicants have contemplated applying the principles, is set forth in the following description, shown in the drawings, and particularly and distinctly pointed out and set forth in the appended claims.

FIG. 1 is a perspective view of a prior art drawer;

FIG. 2 is a perspective view of an exemplary embodiment magnetic drawer organizer, according to the present invention, showing the organizer incorporated into a prior art drawer with portions removed;

FIG. 3 is an exploded perspective view of the insert of the exemplary embodiment magnetic drawer organizer, according to the present invention, shown in FIG. 2; and

FIG. 4 is an exploded perspective view of one of the pegs of the exemplary embodiment magnetic drawer organizer, according to the present invention, shown in FIG. 2.

Similar characters refer to similar parts throughout.

### DESCRIPTION OF THE PREFERRED EMBODIMENT

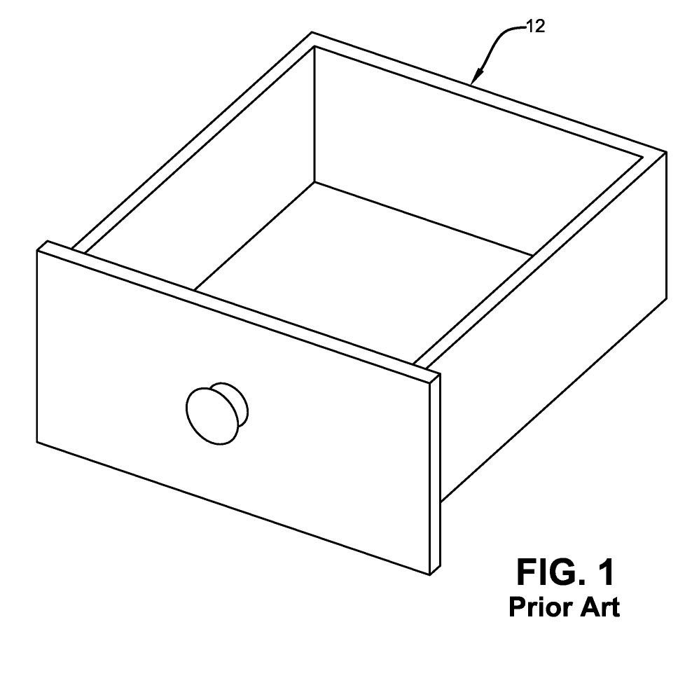

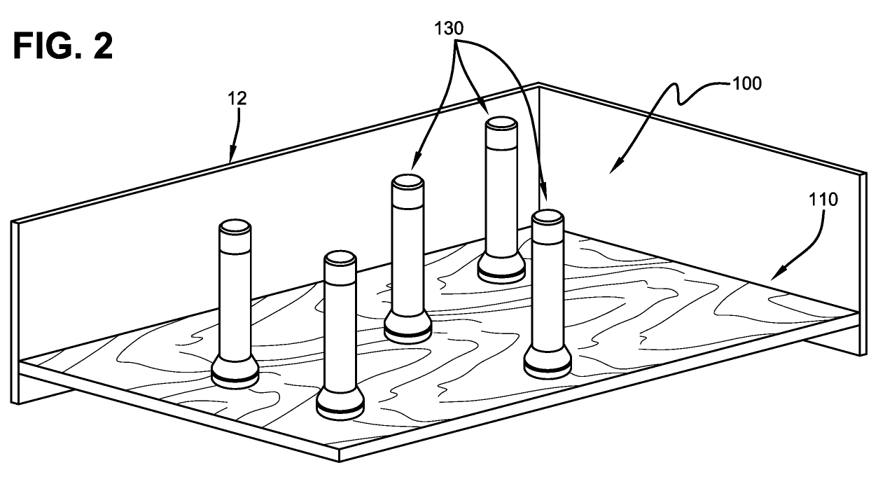

An exemplary embodiment magnetic drawer organizer 100 (FIGS. 2-4), according to the present invention, may be incorporated into or installed within a cabinet or drawer, such as prior art unitized drawer 12 (FIGS. 1-2).

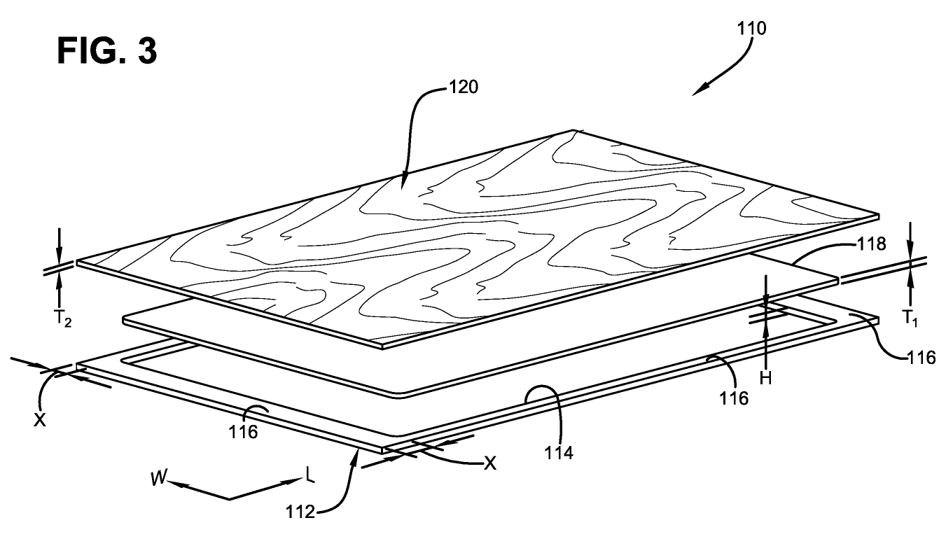

Drawer organizer 100 may include an insert 110 and one or more magnetic pegs 130. Insert 110 may be formed of wood, MDF, or the like, or a combination thereof. More preferably, as shown in FIG. 3, insert 110 is formed from a wood or MDF layer, or base 112. Base 112 may be of any suitable size and shape but is preferably a rectangle sized to be received in drawers designed for unitized cabinetry, such as drawer 12. Base 112 may include a recess 114 formed into the base by any suitable method, such as routing. In particular, recess 114 may be formed with any suitable shape and/or dimensions but may generally be formed as a rectangle of a size that occupies a substantial portion of insert 110. More particularly, recess 114 may extend across insert 110 and be surrounded by a border or margin 116. Margin 116 may have a width or dimension X that extends from recess 114 to the edge of insert 110. More specifically, dimension X of margin 116 may extend along a longitudinal axis L of insert 110 and along a transverse axis W of the insert. Dimension X may have a value along the longitudinal axis L that is different from the dimension extending along transverse axis W of the insert. Recess 114 may also have a depth or dimension H extending into insert 110. Dimension H may be any suitable dimension but is generally in the range of from about 0.03 inches to about 0.15 inches, but is more preferably in the range of from about 0.06 to about 0.09 inches.

In accordance with an important aspect of the present invention, insert 110 also includes an intermediate layer or sheet 118 disposed within recess 114. Sheet 118 may be formed from any suitable ferromagnetic or paramagnetic material, such as steel, in any suitable size or shape. In particular, sheet 118 may be a rectangle, rounded rectangle, or oblong with dimensions corresponding to or slightly less than those of recess 114. More particularly, sheet 118 may be formed from metal having a thickness or dimension T₁ of about 0.06 inches to about 0.09 inches to allow the sheet to be disposed completely within recess 114 such that the sheet does not project or extend above the edge of the recess and forms a relatively level surface with margin 116. As a result, the dimension X of margin 116 provides insert 110 with additional trimmable material around the perimeter of sheet 118, providing installers with the ability to customize the fit of the insert within drawer 12 utilizing common woodworking tools, thereby facilitating faster and more accurate installation. Sheet 118 may be attached to base 112 within recess 114 using any suitable means, such as adhesive, or, alternatively, may be interference-fit within the recess.

Insert 110 includes a veneer or top layer 120 attached to sheet 118 and margin 116 of base 112. In particular, top layer 120 may be formed from any suitable material, such as wood, with any suitable dimensions. More preferably, top layer 120 is formed as a thin sheet of wood or veneer having dimensions equivalent or closely corresponding to the dimensions of base 112 along the longitudinal and transverse axes L, W, respectively. Top layer 120 may also include a thickness or dimension T₂. Dimension T₂ may be any suitable dimension but is preferably between about 0.010 inches to about 0.13 inches, more preferably about 0.024 inches. Top layer 120 may be aligned with and attached to sheet 118 and margin 116 of base 112 using any suitable means, such as adhesive, to complete insert 110. As a result, insert 110 may be trimmed anywhere along margins 116 in order to facilitate installation within drawer 12 or cabinet.

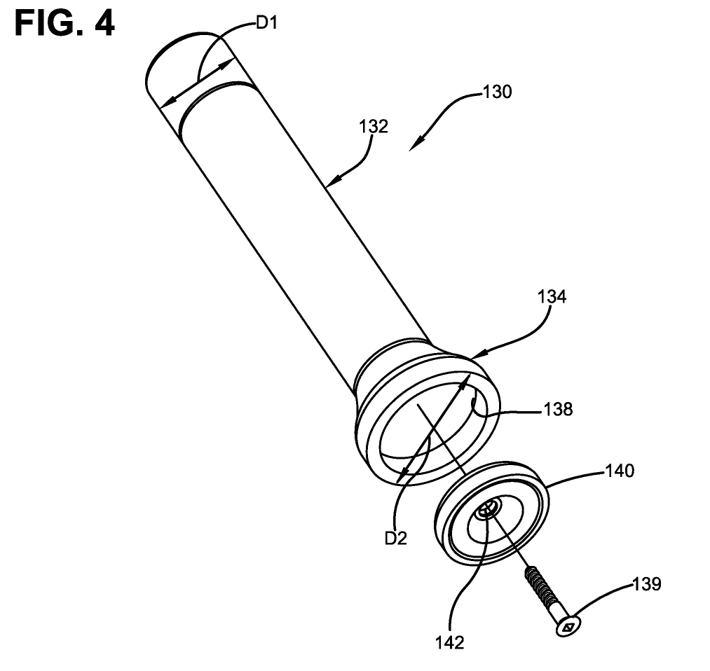

In accordance with another important aspect of the present invention, and with particular reference to FIGS. 2 and 4, drawer organizer 100 includes one or more magnetic pegs 130. Each peg 130 may be formed from any suitable material, such as plastic or wood, with a generally prismatic or cylindrical shape. Peg 130 may have any suitable dimensions and may include an integrally formed upper portion 132 and a lower portion 134. Upper portion 132 may be formed with a prismatic or cylindrical shape having a diameter or dimension D1. Lower portion 134 of each peg 130 may be formed with a flange or flared shape, such as pyramidal, bell-shaped, hemi-spherical, or frustoconical, that has a diameter or dimension D2 at the widest point of the lower portion. Dimension D2 is generally larger than dimension D1. Lower portion 134 may also be formed with a recess 138 extending axially into the axial end of the lower portion. Recess 138 may have any suitable depth but generally corresponds to the thickness of a magnet 140. In particular, magnet 140 may be any suitable type of magnet but is preferably a circular neodymium cup magnet. More particularly, magnet 140 may be inserted into recess 138 of lower portion 134 and attached or retained within the recess using any suitable means, such as adhesive or a fastener 139. Fastener 139 may be disposed through an opening 142 formed through magnet 140 and received within lower portion 134 of peg 130. Because magnet 140 generates a strong magnetic field, and because the magnet is attached to lower portion 134 of peg 130, the peg is attracted and holds strongly to insert 110 of organizer 100. As a result, pegs 130 can be placed in any location on insert 110 to provide a completely custom arrangement of support and/or division of stored items, such as kitchenware. Moreover, because magnet 140 holds peg 130 to insert 110 of organizer 100, the insert provides the functionality of prior art drawer organizers without requiring any exposed and unsightly holes, openings, or recesses formed therein such that the organizer is relatively more sanitary and aesthetically pleasing than the prior art.

Thus, exemplary embodiment magnetic drawer organizer 100 includes insert 110 with margin 116 that provides the organizer with trimmable material, thereby facilitating faster and more accurate installation of the organizer within prior art unitized drawer 12 or a cabinet (not shown). In addition, organizer 100 includes one or more pegs 130 having respective lower portions 134 formed with recesses 138 for receiving magnets 140 to removably attach the pegs to insert 110, providing the organizer with completely customizable placement for the support and division of items stored within drawer 12 or a cabinet (not shown) without the use of holes, openings, and/or recesses formed into the insert, minimizing or eliminating the accumulation of dirt, debris, and/or particulate, thereby preventing unsanitary conditions and creating a more aesthetically pleasing appearance.

It is contemplated that exemplary embodiment magnetic drawer organizer 100, according to the present invention, could be utilized with all types of drawers and cabinets other than those described above, without affecting the overall concept or operation. It is also contemplated that upper and lower portions 132, 134, respectively, of pegs 130 could be formed with shapes and/or sizes other than those shown and described and/or may have magnet 140 mounted at other suitable positions without affecting the overall concept or operation of the invention.

Accordingly, exemplary embodiment magnetic drawer organizer 100 is simplified; provides an effective, safe, inexpensive, and efficient structure and method, which achieve all the enumerated objectives; provide for eliminating difficulties encountered with prior cabinet organizers; and solve problems and obtains new results in the art.

In the foregoing description, certain terms have been used for brevity, clarity, and understanding, but no unnecessary limitations are to be implied therefrom beyond the requirements of the prior art because such terms are used for descriptive purposes and are intended to be broadly construed. Moreover, the description and illustration of the invention is by way of example, and the scope of the invention is not limited to the exact details shown or described.

Having now described the features, discoveries, and principles of the invention; the manner in which the sliding cabinet organizer is used and installed; the characteristics of the construction, arrangement, and method steps; and the advantageous, new, and useful results obtained; the new and useful structures, devices, elements, arrangements, process, parts, and combinations are set forth in the appended claims.

What is claimed is:

1. A magnetic organizer for a drawer or cabinet, said organizer comprising:
an insert disposed within said drawer or cabinet, said insert having a base formed with a first recess for receiving a sheet, said sheet being formed from a ferromagnetic material or paramagnetic material; and
at least one peg, said at least one peg having a second recess for receiving a magnet;
wherein the at least one peg is removably attached to the insert by said magnet.

2. The magnetic organizer of claim 1, said base further comprising a first thickness, said first thickness being the range of from about 0.094 inches to about 0.32 inches.

3. The magnetic organizer of claim 2, said first recess being formed a depth into said base;
said depth being in the range of from about 0.03 inches to about 0.15 inches.

4. The magnetic organizer of claim 3, said depth being in the range of from about 0.06 inches to about 0.09 inches.

5. The magnetic organizer of claim 1, said base further comprising a margin extending from said first recess along a longitudinal axis and a transverse axis of the base, a top surface of said sheet being flush with said margin when disposed within said first recess.

6. The magnetic organizer of claim 5, said margin further comprising a dimension, said dimension being greater along said longitudinal axis than along said transverse axis.

7. The magnetic organizer of claim 4, said insert further comprising a top layer attached to said sheet and said margin of said base.

8. The magnetic organizer of claim 6, said top layer further comprising a second thickness, said second thickness being about 0.024 inches.

9. The magnetic organizer of claim 6, said at least one peg further comprising an upper portion and an integral lower portion;
said second recess being formed in said lower portion.

10. The magnetic organizer of claim 8, said upper portion of said at least one peg further comprising a first dimension;
said lower portion comprising a second dimension, said second dimension being greater than said first dimension.
